(19) United States
(12) Patent Application Publication
(10) Pub. No.: US 2024/0382293 A1
(43) Pub. Date: Nov. 21, 2024

(54) THREE-DIMENSIONAL PRINTED DENTAL IMPLANT WITH EMBEDDED SENSORS

(71) Applicant: International Business Machines Corporation, Armonk, NY (US)

(72) Inventors: Jeremy R. Fox, Georgetown, TX (US); Martin G. Keen, Cary, NC (US); Alexander Reznicek, Troy, NY (US); Bahman Hekmatshoartabari, White Plains, NY (US)

(21) Appl. No.: 18/317,355

(22) Filed: May 15, 2023

(51) Int. Cl. A61C 8/00; B33Y 80/00

(52) U.S. Cl. CPC A61C 8/0093; B33Y 80/00

(57) ABSTRACT

A 3D printed dental implant. The 3D printed dental implant includes a 3D printed dental implant body, and a plurality of sensors embedded within the 3D printed dental implant body.

### BACKGROUND

The present disclosure relates generally to three-dimensional (3D) printing, and more specifically, to a three-dimensional (3D) printed dental implant with embedded sensors for monitoring of implant corrosion.

3D printing, or additive manufacturing, is the construction of a 3D printed object from a computer-aided design (CAD) model or a digital 3D model. It can be done in a variety of processes in which material is deposited, joined or solidified under computer control, with material being added together (such as plastics, liquids or powder grains being fused), typically layer by layer.

### SUMMARY

According to some embodiments of the disclosure, there is provided a 3D printed dental implant. The 3D printed dental implant includes a 3D printed dental implant body, and a plurality of sensors embedded within the 3D printed dental implant body.

According to some embodiments of the disclosure, there is provided a 3D printed dental implant system. The system includes at least one 3D printed dental implant. The at least one 3D printed dental implant includes a 3D printed dental implant body, and a plurality of sensors embedded within the 3D printed dental implant body. The system further includes an interrogator adapted for monitoring the at least one 3D printed dental implant by communicating with the plurality of sensors via a wireless interface.

According to some embodiments of the disclosure, there is provided a method. The method includes an operation of providing at least one 3D printed dental implant, including a 3D printed dental implant body, and a plurality of sensors embedded within the 3D printed dental implant body. The method also includes an operation of monitoring, by an interrogator in communication with the plurality of sensors, a condition relating to the at least one 3D printed dental implant.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates an example three-dimensional (3D printed dental implant system with a 3D printed dental crown with embedded sensors located in an oral cavity, which can be in communication with an interrogator, according to illustrative embodiments.

FIG. 2 illustrates a close-up view of an example 3D printed dental implant with embedded sensors located in jawbone, according to illustrative embodiments.

FIG. 3 illustrates a cross-sectional view of a sensor chip, according to illustrative embodiments.

FIG. 4 illustrates a circuit diagram of a sensor, according to illustrative embodiments.

FIG. 5A illustrates a circuit diagram of a sensor in a first 3D printed dental implant, according to illustrative embodiments.

FIG. 5B illustrates a circuit diagram of a sensor in a second 3D printed dental implant, according to illustrative embodiments.

FIG. 6 is a flowchart of a method, according to illustrative embodiments.

FIG. 7 illustrates a networked computer environment, according to illustrative embodiments.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

Aspects of the present disclosure relate to three-dimensional (3D) printing, and more specifically, to a 3D printed dental implant with embedded sensors for monitoring of implant corrosion.

Dental implants can have a high success rate of about ninety-five (95) percent. Nevertheless, due to various reasons (including poor oral hygiene by patients and indirect physiological factors) implant corrosion can lead to problems such as chronic pain, tissue damage, bone resorption, inflammation, fibrosis, loosening of implant, and infection, for example. Conventional diagnosis methods (primarily by imaging) are expensive and may not detect corrosion at sufficiently earlier stages.

As previously described, 3D printing, or additive manufacturing, is the construction of a 3D printed object from a CAD model or a digital 3D model. It can be done in a variety of processes in which material is deposited, joined or solidified under computer control, with material being added together (such as plastics, liquids or powder grains being fused), typically layer by layer.

3D printing has emerged as a successful technique for creating dental implants, crowns and bridges. Modern 3D printing tools create products that can be indistinguishable from natural teeth. One important feature of 3D printing is customizability. The shape, size, color and position of the crown, bridge or implant and other components can be precisely crafted by 3D or four-dimensional (4D) printing to match the specific needs of a patient.

Disclosed are embodiments of a 3D printed dental implant, bridge or crown (generally referred to as “dental implant”) including one or multiple embedded sensors, which is capable of allowing for monitoring of implant corrosion, for example.

Disclosed are embodiments of a 3D printed dental implant system that can include an interrogator (or reader) apparatus that can be used for periodic monitoring, or real time monitoring, if/when desired, of the 3D printed implant health by communicating with one or multiple embedded sensors incorporated into the 3D printed dental implant. The communication can be via a wireless interface, for example. The interrogator apparatus can be a handheld device, for example.

An advantage of the disclosed embodiments is that the use of embedded sensors in a 3D printed dental implant allows for monitoring of the 3D printed dental implant and for early detection or diagnosis of implant corrosion, for example. Early detection can prompt a patient to correct their behavior (e.g., maintain better oral hygiene) to prevent further degradation and/or to seek dental treatment or advice from a provider.

Another advantage of the disclosed embodiments is that 3D printing of dental implants allows for customizability of shape, size, color, position, etc., of the dental implant to match specific needs of a patient. Similarly, types of sensors infused into the dental implant can be tailored towards the specific needs of the patient.

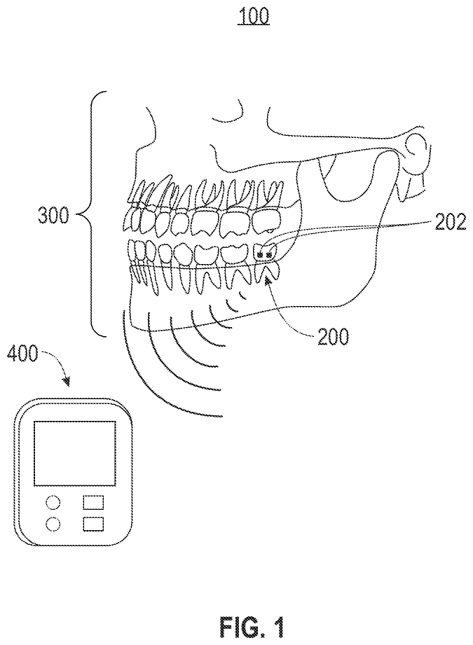

Turning to the figures, FIG. 1 illustrates an example 3D printed dental implant system 100 with a 3D printed dental crown 200 with embedded sensors 202 implanted in an oral cavity 300, which can be in communication with an interrogator 400, according to illustrative embodiments. The system 100 can include the 3D printed dental crown 200 as shown. Alternatives to the 3D printed dental crown 200 can be a 3D printed dental bridge, for example. The 3D printed dental crown 200 is shown implanted at a possible location in the oral cavity 300, although other possible locations are contemplated. The sensors 202 embedded in the 3D printed dental crown 200 are shown in wireless communication with the interrogator 400, which is remote (i.e., situated a distance away from another object) from the 3D printed dental crown 200. The possible communication can relate to pH levels in saliva that can indicate possible corrosion of the 3D printed dental crown 200. The interrogator 400 is one example of a reader, which can be handheld, for example. Other devices for reading or receiving communication from sensors 202 in the 3D printed dental crown 200 are also contemplated and are not limited to those shown.

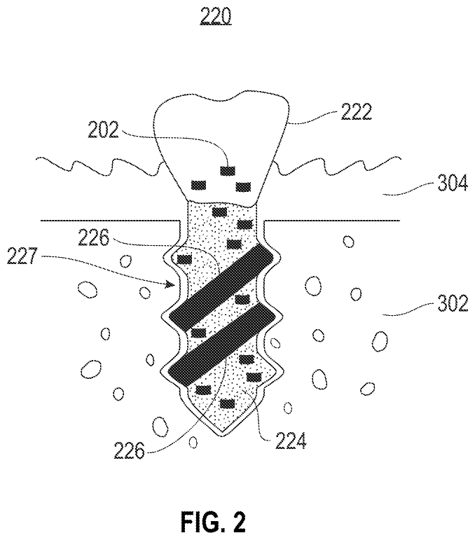

FIG. 2 illustrates a close-up view of an example 3D printed dental implant 220 with embedded sensors 202 located in jawbone 302, according to illustrative embodiments. The example 3D printed dental implant 220 includes a crown 222 that resembles a human tooth and an anchoring member 224 that allows the 3D printed dental implant 220 to be implanted into jawbone 302. The crown 222 can be made of a ceramic material, e.g., porcelain, which is a highly inert material. Corrosion may not occur on the crown 222 portion itself, if made of an inert material. The anchoring member 224 includes a thread 226 along the shank 227 that allows the 3D printed dental implant 220 to be secured into the jawbone 302. The anchoring member 224 can be, for example, made of a metallic material. The embedded sensors 202 can be located in the crown 222 and/or in the shank 227. The embedded sensors 202 can identify certain elements or compounds in saliva 304, for example. Other embedded sensors can identify chemical reactions of corrosion, for example, on portions of the 3D printed dental implant 220, such as on the anchoring member 224. Other components of the 3D printed dental implant 220 can be included, but are not shown or described herein.

The crown 222 of the 3D printed dental implant 220 can be 3D printed to match a crown of a patient's tooth using dental resin materials, for example. 3D printing materials can be used in the 3D printed dental implants disclosed herein, which can include commercially available dental resins. These materials can include, but are not limited to, carrier polymers and inorganic materials, such as ceramics. Other suitable materials for the 3D printed dental implants are also contemplated.

The anchoring member 224 of 3D printed dental implant 220 can be attached to the crown 222 and may or may not be 3D printed. The anchoring member 224 can be made of a biocompatible material such as titanium or tantalum, for example. Other suitable materials for the anchoring member 224 are also contemplated.

Example methods and systems that are capable of making 3D printed dental implants such as 3D printed dental crown 200 are disclosed in a co-pending United States Patent Application. 3D printed objects with the embedded sensors are disclosed in co-pending United States Patent Application having Ser. No. 18/066,439, filed on Dec. 15, 2022, and entitled “EMBEDDED SENSOR CHIPS IN 3D AND 4D PRINTED STRUCTURES THROUGH SELECTIVE FILAMENT INFUSION,” which is incorporated herein by reference in its entirety. Selective infusion of sensor chips into 3D printed objects was disclosed in the co-pending application, and can be used to form 3D printed dental implants, such as 220, with embedded sensors 202. A plurality of sensors 202 can be embedded in in the 3D printed dental implants, such as 220, by selective filament infusion using a 3D printable filament with the plurality of embedded sensors, such as in co-pending United States Patent Application having Ser. No. 18/066,439, filed on Dec. 15, 2022, and entitled “EMBEDDED SENSOR CHIPS IN 3D AND 4D PRINTED STRUCTURES THROUGH SELECTIVE FILAMENT INFUSION,” The plurality of sensors, such as 202, can be embedded homogenously (i.e., alike or similarly) within the 3D printed dental crown 200, for example. Other suitable methods and systems for embedding sensors into a 3D printed object are also contemplated with regard to the present disclosure.

The sensors, such as sensors 202 (FIG. 1 and FIG. 2), that can be included in the 3D printed dental implant can consist of (or include), but are not limited to, sensor chips, sensor chip-lets, chip-less sensors and the like. The sensors can be ion-sensitive field-effect transistor (ISFET) devices. The sensors can include individual sensors or the same or different types, or arrays of sensors of the same or different types.

The sensors, such as sensors 202 (FIG. 1 and FIG. 2), that can be included in the 3D printed dental implant 220 can include a sensing element or material. The sensing element or material can include a circuit component for receiving a wireless signal from an interrogator (or transceiver), such as the interrogator 400 of FIG. 1, and can include a circuit component for sending a wireless signal modulated by a response of the sensing element or material back to the interrogator. The signals backscattered from the multiple sensors (i.e., received back by the interrogator) can be processed or analyzed locally by the interrogator or transmitted to a server/cloud and/or shared with a healthcare provider.

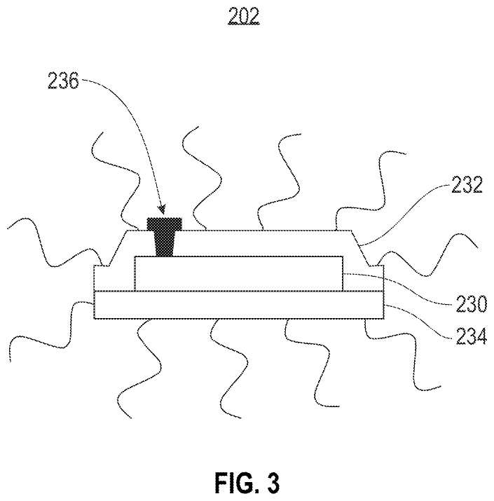

FIG. 3 illustrates a cross-sectional view of a sensor 202 (i.e., an integrated circuit (IC)), according to illustrative embodiments. In one embodiment, the sensor 202 infused into a 3D printed dental crown or implant 200, 220 can include an ISFET (a sensor circuit 230) for sending a pH level of saliva (304 in FIG. 2) in a vicinity of the 3D printed dental implant (220 in FIG. 2). The sensor 202 can include the sensor circuit 230 that is formed on a buried oxide layer 234 of a substrate of the sensor 202. The sensor 202 can include an oxide layer 232 that can be a non-crystalline solid material such as silicon dioxide, undoped silicate glass, fluorosilicate glass, borophosphosilicate glass, a spin-on low-k dielectric layer, a chemical vapor deposition low-k dielectric layer or any combination thereof. The low-k (e.g., k less than about 4.0) dielectric layer can include materials, such as, for example, porous silicates, carbon doped oxides, silicon dioxides, silicon oxynitrides, carbon-doped silicon oxide (SiCOH) and porous variants thereof, silsesquioxanes, siloxanes, or other dielectric materials having, for example, a dielectric constant in the range of about 2 to about 4.

The sensor 202 can include at least one access pad 236 that extends through the oxide layer 232 (i.e., encapsulation). The access pad(s) 236 can be comprised of, or can be coated with, a biocompatible material such as titanium or tantalum. The access pad(s) 236 can be connected to an extended gate (or base) of the sensor circuit 230.

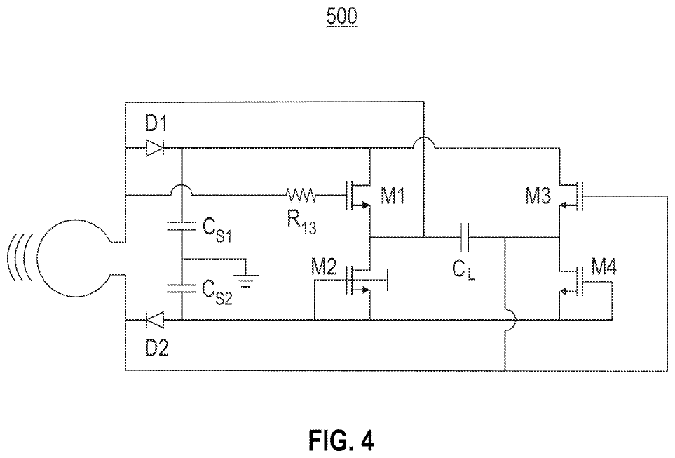

FIG. 4 illustrates a circuit diagram 500 of a sensor (e.g., 202), according to illustrative embodiments. The figure shows one embodiment of a circuit with a differential circuit instead of a single-ended design formed of rectifier diodes D1 and D2, storage capacitors C_{S1} and C_{S2} and output transistors M3 and M4. Backscattered frequency can be transmitted to the interrogator (e.g., 400 in FIG. 1) from the sensor 202, which can be modulated by an electrical response of the ISFET (M2), where an extended gate of M2 can be connected to the access pad(s) (e.g., 236 in FIG. 3).

The sensor 202 and the interrogator 400 of the present disclosure can be like those disclosed in U.S. Pat. No. 10,753,902, filed on Oct. 1, 2018, granted on Aug. 25, 2020, and entitled “CHIPLESS AND WIRELESS SENSOR CIRCUIT AND SENSOR TAG,” which is incorporated herein by reference in its entirety. Other suitable sensors and interrogators (or communication devices) are also contemplated by the disclosure.

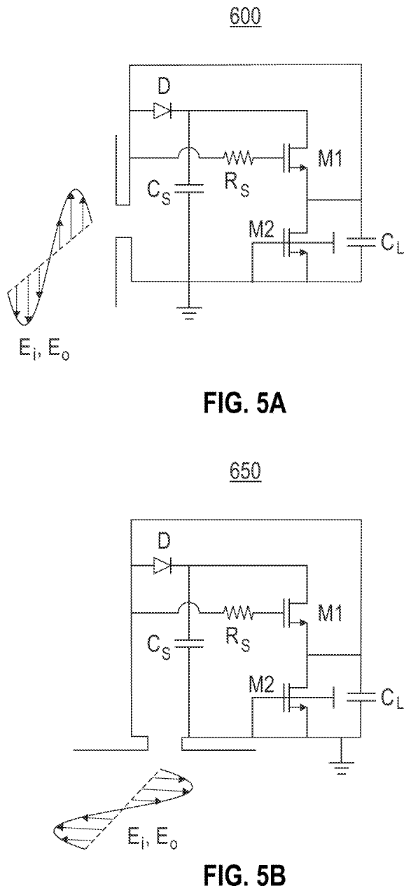

In one embodiment of the disclosure, a 3D printed dental implant system is contemplated in which two 3D printed dental implants are adjacent (or nearby) to each other. In order to minimize signal interference between two sets of infused sensors in the two 3D printed dental implants, antennae in a first set of sensors in a first 3D printed dental implant are chosen to have a linear polarization that is perpendicular to that of antennae in a second set of sensors in a second 3D printed dental implant. In accordance with the embodiment including two 3D printed dental implants, FIG. 5A illustrates a circuit diagram of a sensor circuit 600 in the first 3D printed dental implant, and FIG. 5B illustrates a circuit diagram of a sensor circuit 650 in the second 3D printed dental implant. In the figures, M2 can be an ISFET, e.g., with an extended gate, functionalized for pH measurement.

In one example, the first set of sensors in the first 3D printed dental implant can be infused in a crown of the first 3D printed dental implant. The second 3D printed dental implant can be a crown associated with a root canal. The second set of sensors can be infused in the 3D printed dental crown and can be used as a reference or calibration point to improve overall measurement accuracy, for example. Other systems of using more than one 3D printed dental implant are also contemplated by the disclosure.

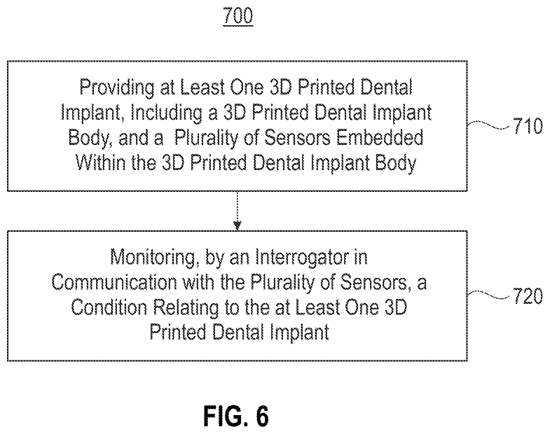

FIG. 6 is a flowchart of a method 700, according to illustrative embodiments. The method 700 includes an operation 710 of providing at least one 3D printed dental implant, including a 3D printed body, and a plurality of sensors embedded within the 3D printed body. The method 700 also includes an operation 720 of monitoring, by an interrogator in communication with the plurality of sensors, a condition relating to the at least one 3D printed dental implant. The monitoring of the at least one 3D printed dental implant can be performed in real time. The monitoring of the at least one 3D printed dental implant can be performed periodically. The condition can include corrosion on the 3D printed dental implant. The condition can also include a pH level of saliva near the 3D printed dental implant.

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

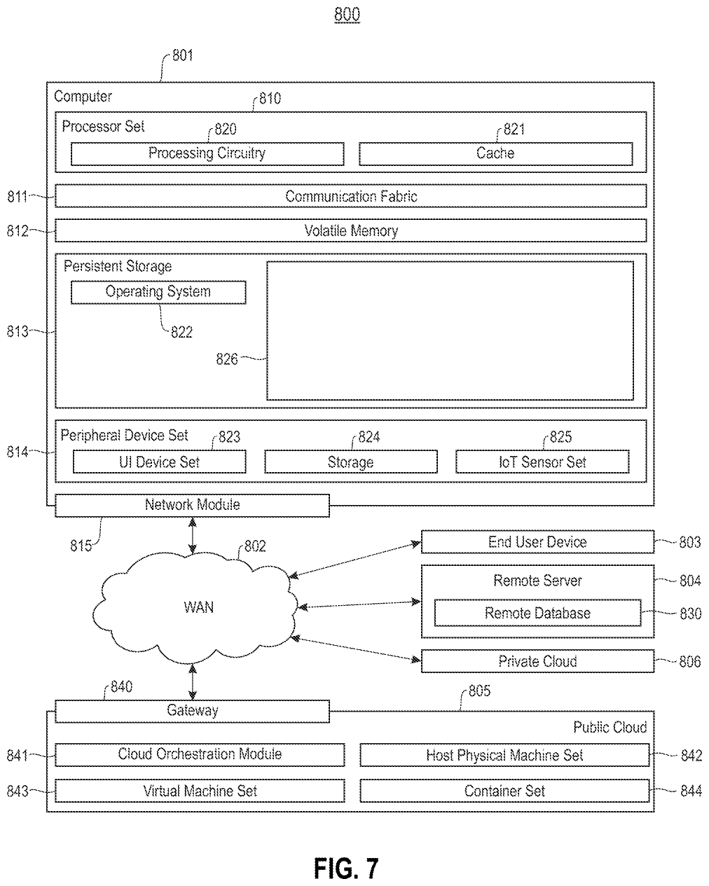

The following described exemplary embodiments provide a system, method and computer program that enables chip-infused filament for 3D printing. Referring now to FIG. 7, Computing environment 800 contains an example of an environment for the execution of at least some of the computer code involved in performing the inventive methods, such as monitoring conditions relating to a 3D printed dental implant. In addition to monitoring conditions relating to a 3D printed dental implant, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and storage module relating to monitoring of 3D printed dental implant 826, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

Computer 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 7. On the other hand, computer 801 is not required to be in a cloud except to any extent as may be affirmatively indicated.

Processor set 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in persistent storage 813.

Communication fabric 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

Persistent storage 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included typically includes at least some of the computer code involved in performing the inventive methods of monitoring conditions relating to a 3D printed dental implant.

Peripheral device set 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

Network module 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

Remote server 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

Public cloud 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

As used in this application and in the claims, the singular forms “a,” “an,” and “the” include the plural forms unless the context clearly dictates otherwise. Additionally, the term “includes” means “comprises.”

“3D printer” is defined as “a machine used for 3D printing” and “3D printing” is defined as “the fabrication of objects through the deposition of a material using a printer (or print) head, nozzle, or another printer technology.”

Synonyms associated with and encompassed by 3D printing include additive fabrication, additive processes, additive techniques, additive layer manufacturing, layer manufacturing, and freeform fabrication. “Additive manufacturing (AM)” is defined as “a process of joining materials to make objects from 3D model data, usually layer upon layer, as opposed to subtractive manufacturing methodologies. Additive manufacturing (AM) may also be referred to as rapid prototyping (RP). As used herein, “3D printing” is generally interchangeable with “additive manufacturing” and vice versa.

“Printing” is defined as depositing of a material using a print head, nozzle, or another printer technology.

In this disclosure, “3D or three dimensional article, object or part” means an article, object or part obtained by additive manufacturing or 3D printing as disclosed above.

In this disclosure, the term “3D printing” covers a variety of processes in which material is joined or solidified under computer control to create a 3D object. Material is added together (such as liquid molecules or powder grains being fused together) typically layer by layer.

In general, all 3D printing processes have a common starting point, which is a computer generated data source or program which may describe an object. The computer generated data source or program can be based on an actual or virtual object. For example, an actual object can be scanned using a 3D scanner and scan data can be used to make the computer generated data source or program. Alternatively, the computer generated data source or program may be designed from scratch.

The computer generated data source or program is typically converted into a standard tessellation language (STL) file format; however other file formats can also or additionally be used. The file is generally read into 3D printing software, which takes the file and optionally user input to separate it into hundreds, thousands, or even millions of “slices.” The 3D printing software typically outputs machine instructions, which may be in the form of G-code, which is read by the 3D printer to build each slice. The machine instructions are transferred to the 3D printer, which then builds the object, layer by layer, based on this slice information in the form of machine instructions. Thicknesses of these slices may vary.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A 3D printed dental implant, comprising:
a 3D printed dental implant body; and
a plurality of sensors embedded within the 3D printed dental implant body.

2. The 3D printed dental implant of claim 1, wherein the plurality of sensors is embedded within the 3D printed dental implant body by 3D printing.

3. The 3D printed dental implant of claim 1, wherein the plurality of sensors is embedded within the 3D printed dental implant body by selective filament infusion using a 3D printable filament with the plurality of embedded sensors.

4. The 3D printed dental implant of claim 1, wherein the plurality of sensors is embedded homogenously within the 3D printed dental implant body.

5. The 3D printed dental implant of claim 1, wherein the plurality of sensors consist of sensor chips, sensor chip-lets, or chip-less sensors.

6. The 3D printed dental implant of claim 1, wherein the plurality of sensors include ion-sensitive field-effect transistor (ISFET) devices.

7. The 3D printed dental implant of claim 1, wherein the plurality of sensors include arrays of sensors of a same or different type.

8. A 3D printed dental implant system, the system comprising:
at least one 3D printed dental implant, including
a 3D printed dental implant body, and
a plurality of sensors embedded within the 3D printed dental implant body; and
an interrogator adapted for monitoring the at least one 3D printed dental implant by communicating with the plurality of sensors via a wireless interface.

9. The 3D printed dental implant system of claim 8, wherein the plurality of sensors and the interrogator are adapted for monitoring of the at least one 3D printed dental implant in real time.

10. The 3D printed dental implant system of claim 8, wherein the plurality of sensors is embedded within the 3D printed dental implant body by 3D printing.

11. The 3D printed dental implant system of claim 8, wherein the plurality of sensors is embedded within the 3D printed dental implant body by selective filament infusion using a 3D printable filament with the plurality of embedded sensors.

12. The 3D printed dental implant system of claim 8, wherein the plurality of sensors is embedded homogenously within the 3D printed dental implant body.

13. The 3D printed dental implant system of claim 8, wherein the plurality of sensors and the interrogator are adapted for monitoring of the at least one 3D printed dental implant periodically.

14. The 3D printed dental implant system of claim 8, wherein the plurality of sensors consist of sensor chips, sensor chip-lets, or chip-less sensors.

15. The 3D printed dental implant system of claim 8, wherein the plurality of sensors include ion-sensitive field-effect transistor (ISFET) devices.

16. The 3D printed dental implant system of claim 8, wherein the plurality of sensors include arrays of sensors of a same or different type.

17. A method, comprising:
providing at least one 3D printed dental implant, including
a 3D printed dental implant body, and
a plurality of sensors embedded within the 3D printed dental implant body; and
monitoring, by an interrogator in communication with the plurality of sensors, a condition relating to the at least one 3D printed dental implant.

18. The method of claim 17, wherein the plurality of sensors is embedded within the 3D printed dental implant body by 3D printing.

19. The method of claim 17, wherein the plurality of sensors is embedded within the 3D printed dental implant body by selective filament infusion using a 3D printable filament with the plurality of embedded sensors.

20. The method of claim 17, wherein the plurality of sensors is embedded homogenously within the 3D printed dental implant body.
